(19) United States
(12) Patent Application Publication
(10) Pub. No.: US 2009/0129995 A1
(43) Pub. Date: May 21, 2009

(54) Method for coating a surface filter with a finely divided solids, filter so obtained and its use

(75) Inventors: Marcus Pfeifer, Solingen (DE); Markus Koegel, Speyer (DE); Christian Kuehn, Hasselroth (DE); Roger Staab, Freigericht (DE); Paul Spurk, Weiterstadt (DE); Egbert Lox, Grebenhain (DE); Thomas Kreuzer, Karben (DE)

Correspondence Address: KALOW & SPRINGUT LLP, 488 MADISON AVENUE, 19TH FLOOR, NEW YORK, NY, 10022, US

(73) Assignee: UMICORE AG & CO. KG, Hanau-Wolfgang (DE)

(21) Appl. No.: 11/660,692

(22) PCT Filed: Aug. 13, 2005
(86) PCT No.: PCT/EP2005/008823

§ 371 Date: Jul. 21, 2008

(30) Foreign Application Priority Data
Aug. 21, 2004 (DE) 10 2004 040 548.4

(51) Int. Cl. B01J 37/02; B01J 35/04; B01D 53/94

(52) U.S. Cl. 422/180; 427/244

(57) ABSTRACT

Coating a wall-flow filter with a catalytically active coating generally increases the exhaust-gas backpressure in the filter. The increase in the exhaust-gas backpressure is particularly pronounced if a slurry of fine-particle catalyst materials is used for the coating operation. The increase in the exhaust-gas backpressure can be restricted to a tolerable level if, prior to the coating operation, the slurry is so finely milled that virtually the entire mass of the catalyst materials is introduced into the pores of the filter and deposited on the inner surfaces of the pores. This is the case if the d₉₀ diameter of the particles in the slurry is reduced to below 5 μm by milling.

The present invention relates to a process for coating an open-pore wall-flow filter with fine-particle solids, in particular a soot filter for diesel engines with a catalytically active coating.

Diesel engines emit soot in addition to unburnt hydrocarbons, carbon monoxide and nitrogen oxides as pollutants. Soot filters are used to remove soot from the exhaust gas. The deposits of soot on the filter cause the exhaust-gas backpressure to increase continuously, thereby reducing the power of the engine. Consequently, the filter has to be regenerated from time to time by burning off the soot.

Among particle filters, a distinction can be drawn between depth filters and surface filters. Typical depth filters comprise, for example, blocks of ceramic foams with an open cell structure or knitted wire fabrics or fibre nonwovens. To separate out the particles contained in gases or liquids, the gases or liquids are passed through the filters. The particles are deposited in the volume of the filter bodies. In the case of surface filters, the particles that are to be removed from the gases or liquids are deposited substantially on the surfaces of thin-walled bodies which consist of materials which likewise have an open cell structure. For filtration purposes, the gases or liquids are passed through the walls of these bodies substantially perpendicular thereto. Consequently, these bodies are also known as wall-flow filters. The particles are deposited predominantly on the entry surface of the walls.

Wall-flow filters preferably consist of ceramic materials, such as for example cordierite, silicon carbide, aluminium titanate and mullite. They are being used in increasingly large numbers to remove soot from the exhaust gas from internal combustion engines, in particular from the exhaust gas from diesel engines. These wall-flow filters are preferably in the form of a honeycomb carrier, which has parallel flow passages for the exhaust gas running from an entry end face to an exit end face; these flow passages are alternatingly plugged at the end faces, so that on its way from the entry end face to the exit end face the exhaust gas is forced to pass through the porous partition walls between the flow passages. This structure divides the flow passages into entry passages and exit passages.

As the filter becomes increasingly laden with soot, the exhaust-gas backpressure increases, and consequently from time to time it is necessary to regenerate the filter by burning the accumulated soot. The spontaneous combustion of the soot commences at an exhaust-gas temperature of approximately 600° C.

Already some time ago, it was attempted to reduce the soot ignition temperature by coating the filter with a catalyst. By way of example, silver vanadate (U.S. Pat. No. 4,455,393), an alkali metal perrhenate or silver perrhenate or a mixture of these substances with lithium oxide, copper(I) chloride, vanadium pentoxide containing 1 to 30% by weight of an alkali metal oxide or a vanadate of lithium, sodium, potassium or cerium (U.S. Pat. No. 4,515,758) are suitable for lowering the soot ignition temperature by approximately 50° C. The soot ignition temperature can also be lowered by a mixture of a platinum group metal with an alkaline-earth metal oxide (U.S. Pat. No. 5,100,632). Mixtures of platinum with cerium oxide, manganese oxide and calcium oxide (WO 02/26379 A1), which can lower the soot ignition temperature by over 100° C., are particularly suitable.

Furthermore, the filter may be equipped with further catalytically active components for oxidizing carbon monoxide and hydrocarbons and for storing nitrogen oxides. For example, U.S. Pat. No. 6,367,246 B1 describes a wall-flow filter which has a coating that absorbs hydrocarbons and stores nitrogen oxides applied to its passage walls.

In the context of the present invention, a distinction is drawn between coating the filter with a slurry of fine-particles, i.e. particulate solids, on the one hand, and coating with an impregnation solution, on the other hand.

The term “fine-particle solids” is to be understood as meaning materials in powder form with mean particle diameters of less than 100, preferably less than 50 μm. In the case of coating slurries for catalysts, the fine-particle solids are generally metal oxides with a high surface area, which serve as support materials for the catalytically active components. The support materials generally have specific surface areas of between 10 and 400 m²/g.

To produce a catalyst coating, these support materials are slurried, for example in water, and then milled to a mean particle size of 2 to 6 μm prior to coating the carrier provided. Experience has shown that this mean particle size produces optimum bonding of the coating on the carrier. If the coating slurry is milled more finely, the coating is observed to have an increased tendency to flake off after the coating operation.

When coating a wall-flow filter with a conventional coating slurry for catalysts, by way of example the slurry is poured over the entry end face. Then, excess material is removed, for example, by allowing it to run out. Next, the filter is dried and then calcined to consolidate the coating. A coating with a thickness of several micrometers remains behind on the wall surfaces of the entry passages. On account of the mean particle size of the slurry of 2 to 6 μm, the coating only penetrates into the pores in the filter body to an insignificant extent. The exit passages can be provided with a coating of this type in a similar way.

In the case of the filter being coated by impregnation, a solution of soluble precursors of the desired metal oxides is produced. The filter body is immersed into this solution. As a consequence, the solution penetrates into the pores of the filter body. The precursors of the metal oxides are converted into the desired oxides by drying and calcining. At the end of this process, the oxides predominantly rest on the inner surfaces of the filter body, which form the pores.

Depending on the pore structure of the wall-flow filter, loading concentrations of up to 70 g of metal oxide per liter of filter body volume can be realized with the aid of a slurry of solids. In the case of filter substrates with mean porosities of 40 to 45% and mean pore diameters of 10 μm, the maximum loading quantity is even only approx. 30 g/l of metal oxide. One drawback is that the exhaust-gas backpressure of the filter is significantly increased by the coating, and consequently concentrations of over 70 g/l are not expedient.

U.S. Pat. No. 4,455,393 describes the coating of a wall-flow filter with silver vanadate. In the case of coating with a concentration of approximately 21 g/l, the soot ignition temperature is lowered by approximately 50° C., while the exhaust-gas backpressure rises by approximately 50% as a result of the coating. U.S. Pat. No. 5,100,632 describes the impregnation of a wall-flow filter with aqueous solutions of platinum group metal salts and alkaline-earth metal salts. This achieves a loading concentration of, for example, 7 g of magnesium oxide per liter of filter body.

The impregnation process can in principle yield similar loading concentrations to those achieved with a slurry. It is advantageous in this context that for the same loading concentration the exhaust-gas backpressure is increased to a significantly lesser extent when using impregnation than when coating with a slurry. However, the impregnation technique is subject to considerable restrictions in terms of the materials properties which can be achieved. The variety and quality of substances which are produced by calcining of the precursor compounds in the pores are far less than those which are well known to be achieved with prefabricated powder materials. By way of example, the specific (BET) surface areas of compounds applied by means of impregnation are generally lower by a factor of ten after calcining than those achieved by slurry coatings.

Therefore, there continues to be a demand for a process for coating open-pore wall-flow filters with particulate solids which reduces the extent of the increase in the exhaust-gas backpressure which is known from conventional coating processes.

This object is achieved by a process for coating an open-pore wall-flow filter with particulate solids, using a slurry of the solids in water and/or an organic liquid for the coating operation. The process is characterized in that the slurry is so finely milled that the coating operation introduces virtually the entire mass of the solids into the pores of the filter, so that it is deposited on the inner surfaces of the pores.

The degree of milling depends on the porosity, the pore size and the pore structure of the particulate filter. Standard wall-flow filters have porosities of between 30 and 95% and mean pore diameters of between 10 and 50 μm. The porosity is preferably between 45 and 90%. However, it is not the mean pore diameters which are crucial for the introduction of the coating material into the pores, but rather the connecting channels between the pores, and in particular the pore openings, at the surface of the particulate filter.

These pore openings and connecting channels are generally significantly smaller than the mean diameters of the pores themselves. It has been found that where possible all the particles of solids in the slurry must have a diameter of less than approximately 10 μm in order to ensure that the majority of the solids particles can penetrate into the pores in the filter. This condition is satisfied to a sufficient extent if the d₉₀ diameter of the solids particles is less than 10 μm. The term d₉₀ means that the volume of the particles with particle sizes of less than d₉₀ is cumulatively less than 90% of the volume of all the particles. Depending on the actual pore structure of the filter, it may be necessary for the slurry to be so finely milled that the d₉₀ diameter is less than 5 μm.

On account of the small particle size in the slurry, the filter has only a low filtering action on the slurry. Therefore, the coating of the filter can be carried out using the known coating processes for conventional flow-through honeycomb bodies. These include, for example, immersing the filter into the slurry, pouring the slurry over the filter or sucking or pumping the slurry into the filter. After the coating operation, excess slurry is removed from the filter by centrifuging, blowing or sucking. Finally, the filter is then dried and if appropriate calcined. The drying is usually carried out at an elevated temperature of between 50 and 150° C., and the calcining at temperatures between 250 and 600° C. for a period of 1 to 5 hours.

The process according to the invention is preferably suitable for the coating of wall-flow filters made from ceramic material, in particular from silicon carbide, cordierite, aluminium titanate or mullite.

Preferred coating materials are those which are suitable for the production of oxidation catalysts, nitrogen oxide storage catalysts, catalysts that reduce the soot ignition temperature or SCR catalysts, and are in particular solids in powder form selected from the group consisting of aluminium oxide, silicon dioxide, titanium oxide, zirconium oxide, cerium oxide and mixtures or mixed oxides thereof. These solids may also be stabilized with respect to thermal damage by being doped with rare earth oxides, alkaline-earth metal oxides or silicon dioxide.

According to the invention, to produce a particle filter equipped with a diesel oxidation catalyst, the particle filter is coated with active aluminium oxide, which has been thermally stabilized by doping with barium oxide, lanthanum oxide or silicon dioxide, with the doping elements being present in a concentration of from 1 to 40% by weight, calculated as oxide and based on the total weight of the stabilized aluminium oxide.

To lower the soot ignition temperature, it is preferable for the particulate filter to be coated with a cerium/zirconium mixed oxide. This material may, for example, be thermally stabilized by doping with praseodymium oxide.

The solids in powder form may have been activated with at least one catalytically active metal component prior to the coating of the filter, in which case it is preferable to use for this purpose the platinum group metals platinum, palladium, rhodium and iridium. After the filter has been coated, it can be impregnated with further catalytically active metal components or promoters by using soluble precursors of these components. After the impregnation step, the filter is dried again and then calcined in order to convert the catalytically active metal components and promoters into their final form.

Of course, the catalytic activation of the solids in the pores of the filter may also be carried out in full only after the filter has been coated, by impregnation with soluble precursors of the corresponding catalytically active metal components.

The following examples and comparative examples and the figures are intended to provide a further explanation of the present invention. In the drawing:

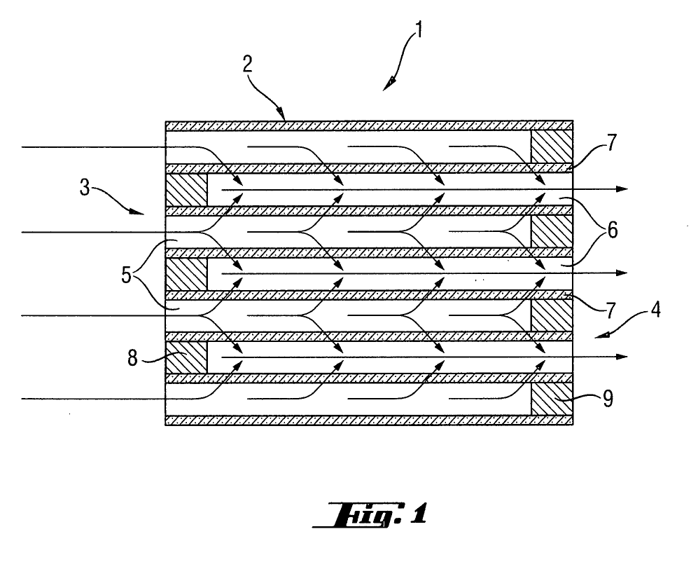

FIG. 1 shows a longitudinal section through a wall-flow filter

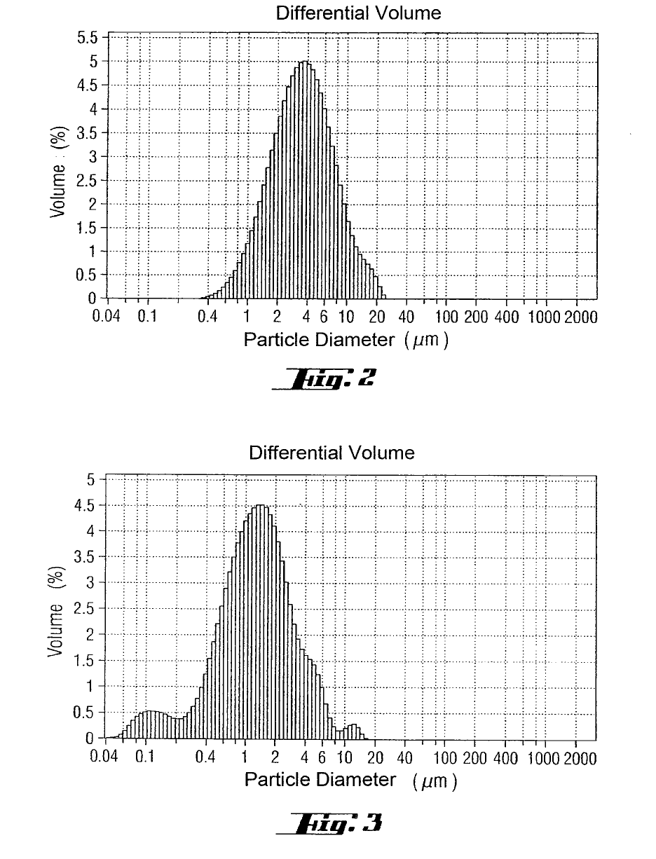

FIG. 2 shows a grain size distribution of a conventionally milled catalyst slurry

FIG. 3 shows a grain size distribution of a catalyst slurry which has been milled in accordance with the invention.

FIG. 1 diagrammatically depicts a longitudinal section through a wall-flow filter (1).

The filter is cylindrical in form, with a lateral surface (2), an entry end face (3) and an exit end face (4). The filter has flow passages (5) and (6) for the exhaust gas distributed over its circumference, the flow passages being separated from one another by the passage walls (7). The flow passages are alternatingly closed at the entry and exit end faces by gastight plugs (8) and (9). The flow passages (5) which are open at the entry side form the entry passages, and the flow passages (6) which are open at the exit side form the exit passages for the exhaust gas. The exhaust gas that is to be purified enters the entry passages of the filter and to pass through the filter has to move from the entry passages into the exit passages through the porous passage walls (7).

For the examples, wall-flow filters made from silicon carbide with a porosity of 42% and mean pore sizes of 11 μm were used. Test bodies with dimensions of diameter of 143.8 mm and length 150 mm were coated with a platinum catalyst supported on aluminium oxide both conventionally and in the manner according to the invention.

### COMPARATIVE EXAMPLE

Aluminium oxide with a mean particle size of 10 μm was activated with 5% by weight of platinum by impregnation, drying and calcining. Then, the activated material was slurried in water and milled with a ball mill to a standard particle diameter d₅₀ of 3 to 4 μm. The particle size distribution obtained in the slurry is illustrated in FIG. 2. The d₉₀ diameter was 9.1 μm. The solids content of the slurry was 30% by weight.

The slurry was introduced into the entry passages of the filter by being pumped in from below, then dried and calcined. The coating concentration was 26 g/l of the wall-flow filter. The coating was located substantially on the walls of the entry passages of the filter.

The back-pressure measurement on the coated filter revealed a backpressure of 24.3 mbar at a volumetric flow of 300 m³/h (s.t.p.). For comparison, that of the uncoated substrate was 15.0 mbar. The backpressure of 24.3 mbar is not acceptable for practical applications on an engine.

### EXAMPLE

Aluminium oxide with a mean particle size of 10 μm was activated with 5% by weight of platinum by impregnation, drying and calcining. Then, the activated material was slurried in water and milled with a ball mill to a particle diameter d₉₀ of 3.8 μm in accordance with the invention. The associated mean particle diameter d₅₀ was 1.4 to 1.6 μm. The particle size distribution obtained in the slurry is illustrated in FIG. 3. The solids content of the slurry was 30% by weight.

The slurry was introduced into the entry passages of the filter by being pumped in from below, then dried and calcined. The coating concentration, as in the comparative example, was 26 g/l of the wall-flow filter. The coating was located substantially within the pores in the passage walls.

The back-pressure measurement on the coated filter revealed a backpressure of 18.5 mbar at a volumetric flow of 300 m³/h (s.t.p.). For comparison, that of the uncoated substrate was 15.1 mbar.

These measurements demonstrate that the filter coated in accordance with the invention has a significantly lower exhaust-gas backpressure for the same loading concentration than the conventionally coated filter. Alternatively, the filter which has been coated in accordance with the invention, for the same exhaust-gas backpressure as that achieved by a conventionally coated filter, can be provided with a higher loading concentration and therefore a stronger catalytic activity.

1. Process for coating an open-pore wall-flow filter with particulate solids using a slurry of the solids in water and/or an organic liquid, the particulate filter having a porosity of between 30 and 95%, with mean pore diameters of between 10 and 50 μm, characterized in that the slurry is so finely milled that the coating operation introduces virtually the entire mass of the solids into the pores of the filter, so that it is deposited on the inner surfaces of the pores.

2. Process according to claim 1, characterized in that the slurry is so finely milled that the particles of the solids have a diameter d₉₀ of less than 10 μm.

3. Process according to claim 2, characterized in that the slurry is so finely milled that the particles of the solids have a diameter d₉₀ of less than 5 μm.

4. Process according to claim 1, characterized in that the filter is coated by being immersed in the slurry, by the slurry being poured over it or by the slurry being sucked or pumped into it.

5. Process according to claim 4, characterized in that the filter is finally dried and calcined.

6. Process according to claim 1, characterized in that the wall-flow filter consists of ceramic material, such as silicon carbide, cordierite, aluminium titanate or mullite.

7. Process according to claim 6, characterized in that the particulate solids are selected from the group consisting of aluminium oxide, silicon dioxide, titanium oxide, zirconium oxide, cerium oxide and mixtures or mixed oxides thereof.

8. Process according to claim 7, characterized in that the solids are thermally stabilized by being doped with rare earth oxides, alkaline earth metal oxides or silicon dioxide.

9. Process according to claim 8, characterized in that the particulate solids contain at least one active aluminium oxide, which has been thermally stabilized by doping with barium oxide, lanthanum oxide or silicon dioxide, with the doping elements being present in a concentration of from 1 to 40% by weight, calculated as oxide and based on the total weight of the stabilized aluminium oxide.

10. Process according to claim 9, characterized in that the particulate solids contain at least one cerium/zirconium mixed oxide, which if appropriate may have been thermally stabilized by doping with praseodymium oxide.

11. Process according to claim 7, characterized in that the particulate solids were activated with at least one catalytically active metal component prior to the coating of the filter.

12. Process according to claim 11, characterized in that the at least one catalytically active metal component is selected from the group of the platinum group metals consisting of platinum, palladium, rhodium and iridium.

13. Process according to claim 12, characterized in that after the catalytically activated solids have been introduced into the pores of the filter, the filter is addition-ally impregnated with a soluble precursor of a further catalytically active metal component, is dried and finally is calcined.

14. Process according to claim 7, characterized in that after the particulate solids have been introduced into the pores in the filter, the filter is impregnated with a soluble precursor of a catalytically active metal component, is dried and finally is calcined.

15. Particle filter with a catalytically active coating based on catalytically activated support materials, characterized in that virtually 100% of the catalytically active coating has been deposited into the pores of the particle filter, with the support materials having a d₉₀ diameter of less than 5 μm and having been obtained by milling particulate solids.
